(19) United States
(12) Patent Application Publication
(10) Pub. No.: US 2024/0023149 A1
(43) Pub. Date: Jan. 18, 2024

(54) BASE STATION, TERMINAL DEVICE, AND TRANSMISSION METHOD IN WIRELESS COMMUNICATION SYSTEM

(71) Applicant: INSTITUTE FOR INFORMATION INDUSTRY, TAIPEI (TW)

(72) Inventor: Yen-Chih KUO, TAIPEI (TW)

(21) Appl. No.: 18/056,245

(22) Filed: Nov. 16, 2022

Related U.S. Application Data
(60) Provisional application No. 63/389,948, filed on Jul. 18, 2022.

(51) Int. Cl. H04W 72/12; H04W 72/14; H04W 28/02

(52) U.S. Cl. CPC H04W 72/1226; H04W 72/1268; H04W 72/14; H04W 28/0278

(57) ABSTRACT

A base station, terminal device, and transmission method in wireless communication system are provided. The terminal device receives an uplink grant signal. The terminal device transmits a buffer status reporting to the base station, the buffer status reporting indicates a first transmission data among a plurality of transmission data and a first time class among a plurality of time classes corresponding to the first transmission data. The base station determines a data transmission schedule for the first transmission data based on the first time class and a remaining delay budget table.

### CROSS-REFERENCE TO RELATED APPLICATION

This application claims priority to U.S. Provisional Application Ser. No. 63/389,948, filed Jul. 18, 2022, which is herein incorporated by reference in its entirety.

### BACKGROUND

### Field of Invention

The present invention relates to a base station, terminal device, and transmission method. More particularly, the present invention relates to a base station, terminal device, and transmission method in a wireless communication system that can improve the efficiency of resource scheduling.

### Description of Related Art

In today's 5G network, in order to support the application requirements of Extended Reality (XR), the packets to be transmitted (i.e., the transmission data) by the terminal device will correspond to a packet delay budget (PDB), and the packet needs to complete within the time limit (i.e., before the delay budget expires).

In this case, if the transmission of the packet to the base station has expired (i.e., the execution time exceeds the time limit of the delay budget), since the packet has no processing benefit, computing and transmission resources may be wasted.

However, in the existing buffer status reporting (BSR) mechanism, since the terminal device only determines the order of transmission according to the priority of the data, when the low-priority data arrives at the base station and the execution time exceeds the time limit, the data will be discarded and the resources will be wasted. In addition, since the base station cannot know the delay budget requirement of the terminal device to execute the resource allocation, data with a lower remaining delay budget (RDB) may not be delivered first. Therefore, the existing buffer state reporting mechanism cannot meet the delay budget requirements of 5G networks in Extended Reality applications.

Accordingly, there is an urgent need for a base station, terminal device, and transmission method in a wireless communication system that can improve scheduling efficiency.

### SUMMARY

An objective of the present disclosure is to provide a terminal device in a wireless communication system. The terminal device includes a storage, a transceiver interface, and a processor. The storage is configured to store a remaining delay budget table and a set of instructions or programs. The processor is electrically connected to the storage and the transceiver interface. The processor is configured to execute following operations when executing the set of instructions or programs. The processor receives an uplink grant signal. The processor transmits a BSR to a base station, wherein the BSR indicates a first transmission data among a plurality of transmission data and a first time class among a plurality of time classes corresponding to the first transmission data. The base station determines a data transmission schedule of the first transmission data based on the first time class and the remaining delay budget table, and the remaining delay budget table includes the time classes and a remaining delay budget value corresponding to each of the time classes.

Another objective of the present disclosure is to provide a base station in a wireless communication system. The base station includes a storage, a transceiver interface, and a processor. The storage is configured to store a remaining delay budget table and a set of instructions or programs. The processor is electrically connected to the storage and the transceiver interface. The processor is configured to execute following operations when executing the set of instructions or programs. The processor transmits an uplink grant signal to a terminal device. The processor receives a BSR from the terminal device, wherein the BSR indicates a first transmission data among a plurality of transmission data and a first time class among a plurality of time classes corresponding to the first transmission data, wherein the remaining delay budget table includes the time classes and a remaining delay budget value corresponding to each of the time classes. The processor receives an urgent data indicator from the terminal device. The processor transmits an urgent data indicator feedback to the terminal device, wherein the terminal device determines whether to transmit the BSR according to the urgent data indicator feedback.

Another objective of the present disclosure is to provide a transmission method, which is adapted for use in a terminal device. The transmission method includes following steps: receiving an uplink grant signal; transmitting a BSR to a base station, wherein the BSR indicates a first transmission data among a plurality of transmission data and a first time class among a plurality of time classes corresponding to the first transmission data; wherein the base station determines a data transmission schedule of the first transmission data based on the first time class and a remaining delay budget table, wherein the remaining delay budget table includes the time classes and a remaining delay budget value corresponding to each of the time classes.

Another objective of the present disclosure is to provide a transmission method, which is adapted for use in a base station. The transmission method includes following steps: transmitting an uplink grant signal to a terminal device; receiving a BSR from the terminal device, wherein the BSR indicates a first transmission data among a plurality of transmission data and a first time class among a plurality of time classes corresponding to the first transmission data, wherein the remaining delay budget table includes the time classes and a remaining delay budget value corresponding to each of the time classes; receiving an urgent data indicator from the terminal device; and transmitting an urgent data indicator feedback, wherein the terminal device determines whether to transmit the BSR according to the urgent data indicator feedback.

According to the above descriptions, the transmission technology (including the base station, the terminal device, and the method) in the wireless communication system provided by the present disclosure calculates the corresponding remaining delay budget value for each of the transmission data by the terminal device, and transmits the remaining delay budget value in the BSR to share information to the base station. In addition, the transmission technology provided by the present disclosure also shares various mechanisms for scheduling information through the terminal device and the base station, so that the transmission data to the base station can be carried out within the time limit. Therefore, the accuracy of the terminal device determining the transmission data is improved, and the efficiency of the base station scheduling is improved.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a wireless communication system of the embodiment of the present disclosure;

FIG. 2 is a schematic view depicting a base station of the embodiment of the present disclosure;

FIG. 3 is a schematic view depicting a terminal device of the embodiment of the present disclosure;

FIG. 4 is a schematic view depicting a remaining delay budget table of some embodiments;

FIG. 5A is a schematic view depicting operations of some embodiments;

FIG. 5B is a schematic view depicting operations of some embodiments;

FIG. 5C is a schematic view depicting operations of some embodiments;

FIG. 5D is a schematic view depicting operations of some embodiments;

FIG. 6 is a partial flowchart depicting a transmission method of the fifth embodiment; and

FIG. 7 is a partial flowchart depicting a transmission method of the sixth embodiment.

### DETAILED DESCRIPTION

In the following description, a base station, terminal device, and transmission method in a wireless communication system according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

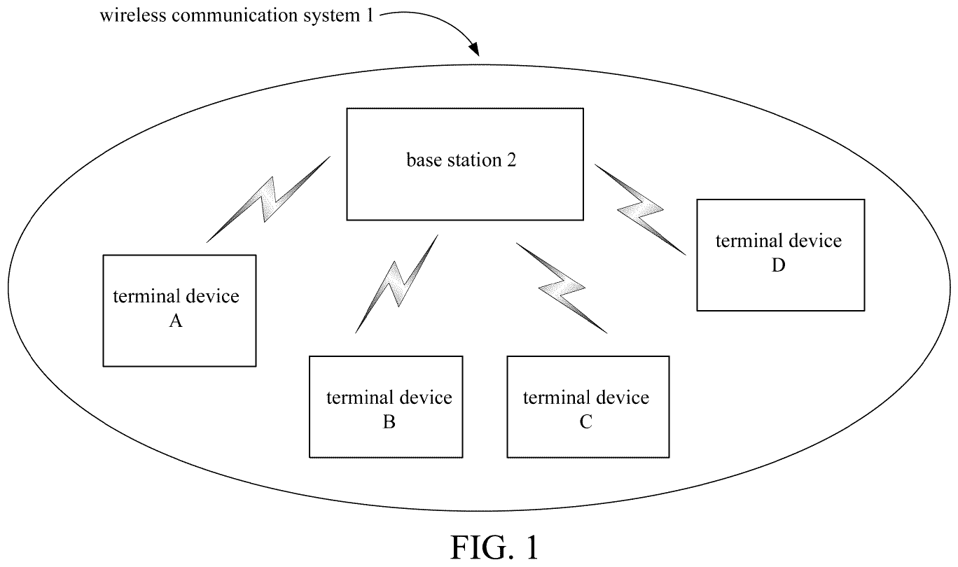

First, the applicable scene of the present embodiment will be described, and a schematic view is depicted in FIG. 1. As shown in FIG. 1, the wireless communication system 1 includes a base station 2 and a plurality of terminal devices A, B, C and D. In this scenario, the terminal devices A, B, C and D are communicatively connected to the base station 2 (e.g., via a 5G or 6G network).

It shall be appreciated that the base station 2 is a base station that provides network services (e.g., a base station gNB in a 5G network), and the terminal devices A, B, C, and D may be, for example, terminal devices that need to upload data. In this scenario, after the terminal devices A, B, C and D respectively request the base station 2 to upload data, the base station 2 determines the data transmission schedule. It shall be appreciated that the present disclosure does not limit the number of terminal devices in the wireless communication system 1 (i.e., the number of terminal devices that are connected to the base station 2 for communication).

For the convenience of description, the following paragraphs will take the base station 2 and the terminal device A among the terminal devices A, B, C and D as the devices executing the transmission operation this time. It shall be appreciated that, in other embodiments, the same transmission operation can also be implemented by the terminal device B, C or D (i.e., one or more second client devices), so it is not repeated here.

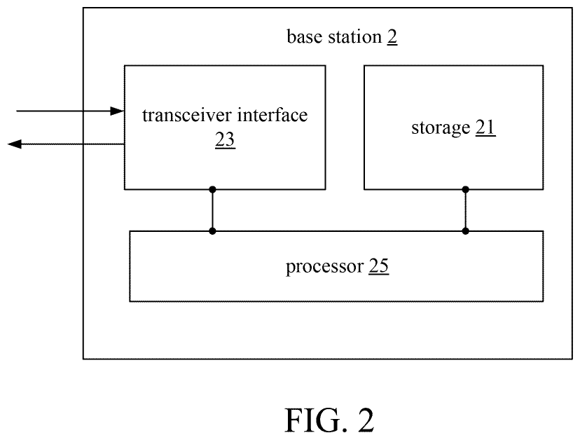

In the present embodiment, a schematic view of the base station 2 is depicted in FIG. 2. The base station 2 includes a storage 21, a transceiver interface 23, and a processor 25. The processor 25 is electrically connected to the storage 21 and the transceiver interface 23.

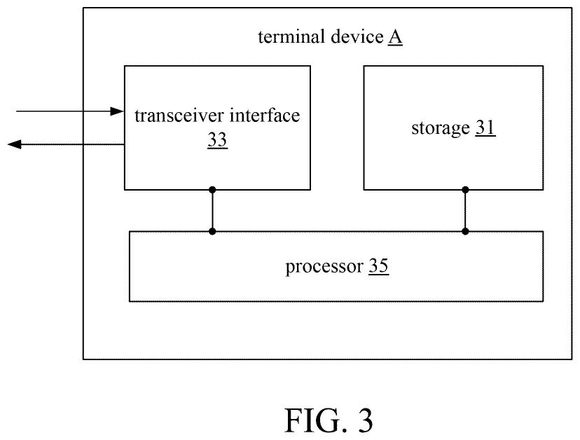

In addition, in the present embodiment, a schematic view of the terminal device A is depicted in FIG. 3. The terminal device A includes a storage 31, a transceiver interface 33, and a processor 35. The processor 35 is electrically connected to the storage 31 and the transceiver interface 33.

It shall be appreciated that each of the storage 21 and the storage 31 may be a memory, a Universal Serial Bus (USB) disk, a hard disk, a Compact Disk (CD), a mobile disk, or any other storage medium or circuit known to those of ordinary skill in the art and having the same functionality. Each of the transceiver interface 23 and the transceiver interface 33 is an interface capable of receiving and transmitting data or other interfaces capable of receiving and transmitting data and known to those of ordinary skill in the art. The transceiver interface 23 and the transceiver interface 33 can receive data from sources such as external apparatuses, external web pages, external applications, and so on. Each of the processor 25 and the processor 35 may be any of various processors, Central Processing Units (CPUs), microprocessors, digital signal processors or other computing apparatuses known to those of ordinary skill in the art.

In the implementation of the present disclosure, each of the base station 2 and the terminal devices A, B, C, and D stores a remaining delay budget table, and each of the base station 2 and the terminal devices A, B, C, and D may classify a plurality of transmission data into corresponding time classes based on the remaining delay budget table. Specifically, the remaining delay budget table includes the time classes and the remaining delay budget value corresponding to each of the time classes.

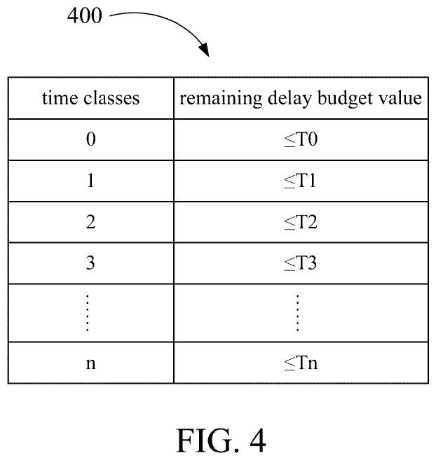

For ease of understanding, please refer to the schematic view of the remaining delay budget table 400 in FIG. 4. As shown in FIG. 4, the remaining delay budget table 400 includes time classes 0, 1, 2, 3, . . . , n, and each of the time classes 0 to n corresponds to the remaining delay budget value “≤T0”, “≤T1”, “≤T2”, “≤T3”, . . . , “≤Tn”, where n is a positive integer.

For example, T0, T1, T2, and T3 may correspond to 10 ms, 20 ms, 30 ms, and 40 ms, respectively. When the remaining delay budget value of the transmission data is 5 ms (i.e., less than T0), the transmission data is correspond to the time class 0. When the remaining delay budget value of the transmission data is 15 ms (i.e., greater than T0 and less than T1), the transmission data is correspond to the time class 1.

It shall be appreciated that the remaining delay budget table can be generated in a number of different ways. For example, the remaining delay budget table can be determined by each terminal device and then transmitted to the base station 2 for storing (i.e., each terminal device has a different remaining delay budget table). For another example, the remaining delay budget table may be generated by the base station 2 and then transmitted to the terminal device for storing (i.e., each terminal device has the same remaining delay budget table). For another example, the remaining delay budget table can be determined by an external device, and then transmitted to the base station 2 and the terminal device for storing (i.e., each terminal device has the same remaining delay budget table).

The specific operations of various embodiments of the present disclosure will be described in detail below. It shall be appreciated that, in various embodiments, the terminal device A has a plurality of data to be transmitted (e.g., packets), and each of the transmission data corresponds to a delay budget.

For example, the terminal device A may include the transmission data D1, the transmission data D2, and the transmission data D3 with delay budgets of 30 ms, 50 ms, and 100 ms, respectively.

The specific operation of the first embodiment will be described in detail below. In short, in the first embodiment, when the terminal device A receives the uplink grant signal from the base station 2, in addition to the original priority of the transmission data (e.g., according to the standard set by Rel-17), the terminal device A may further assign the corresponding class of the transmission data according to the remaining delay budget value corresponding to each transmission data, respectively. The terminal device A may select the transmission data with higher class and priority (e.g., top n transmission data with higher class and priority, and n is a positive integer) to execute the operation of the BSR.

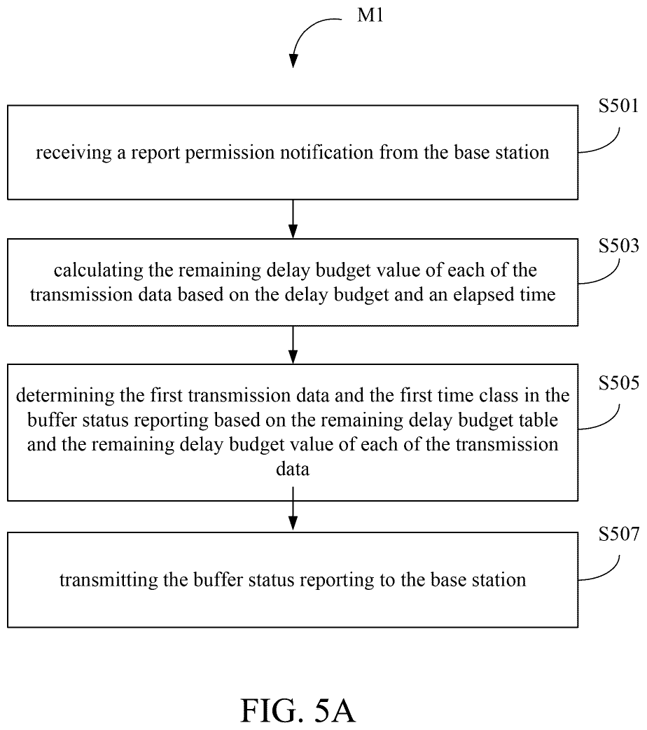

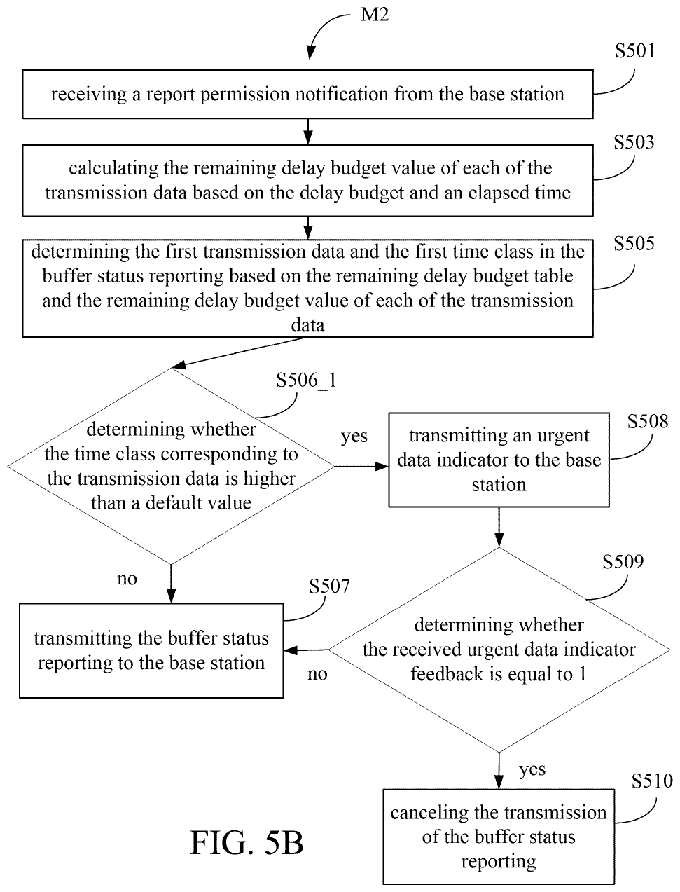

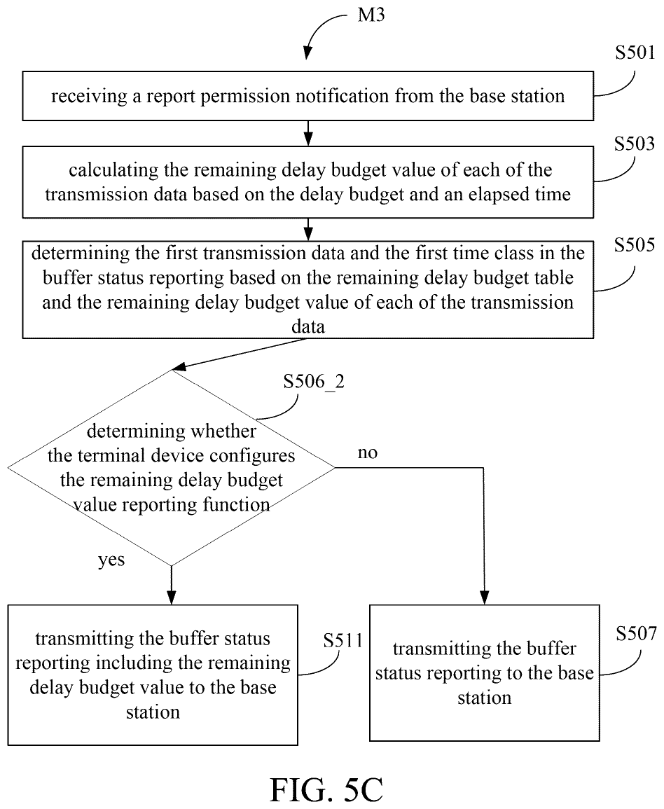

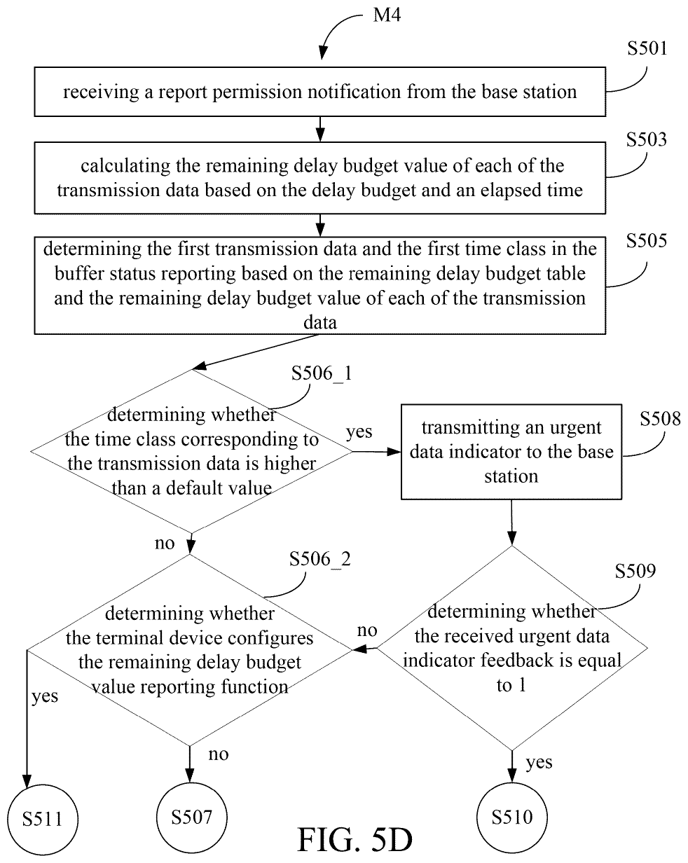

For ease of understanding, please refer to the operation flow chart M1 of FIG. 5A. First, in the operation S501, the terminal device A receives a report permission notification (i.e., an uplink grant signal) from the base station 2, and the report permission notification instructs that the terminal device A may transmit the BSR within a specified time.

Next, the terminal device A generates a BSR, wherein the BSR indicates a first transmission data (i.e., including one or multiple transmission data with higher class) among the plurality of transmission data and a first time class among a plurality of time classes corresponding to the first transmission data (i.e., including one or multiple time class corresponding to the first transmission data). Then, in the operation S507, the terminal device A transmits the BSR to the base station 2.

In some embodiments, the terminal device A determines the BSR based on the operations S503 and S505. First, in the operation S503, the terminal device A calculates the remaining delay budget value of each of the transmission data based on the delay budget and an elapsed time.

For example, taking the transmission data D1, the transmission data D2, and the transmission data D3 mentioned above as an example, when the terminal device A elapses 20 ms of the time, the remaining delay budget values corresponding to the transmission data D1, the transmission data D2, and the transmission data D3 are 10 ms, 30 ms, and 80 ms, respectively (i.e., 20 ms are deducted from each delay budget). It shall be appreciated that, since the terminal device A has a plurality of transmission data to be processed at different time points, the elapsed time is calculated based on the time that the transmission data exists in the terminal device A.

Next, in the operation S505, the terminal device A determines the first transmission data and the first time class in the BSR based on the remaining delay budget table and the remaining delay budget value of each of the transmission data.

Finally, after receiving the BSR transmitted by the terminal device A, the base station 2 determines a data transmission schedule for the first transmission data based on the first time class and the remaining delay budget table.

In some embodiments, the base station 2 may determine the data transmission schedule of the first transmission data based on the remaining time corresponding to the first time class. Specifically, the data transmission schedule is determined based on following operations: comparing the remaining delay budget table to obtain the remaining delay budget value corresponding to the first time class; and determining the data transmission schedule of the first transmission data based on the remaining delay budget value corresponding to the first time class.

In some embodiments, when there are a plurality of transmission data with the same time class, the terminal device A may determine the transmission data (i.e., the first transmission data) in the BSR according to the priority level (e.g., the standard set by Rel-17). Specifically, each of the transmission data is further corresponding to a priority level, and the first transmission data is generated based on following operation: in response to the transmission data including a plurality of third transmission data corresponding to the same time class, determining the first transmission data based on the priority levels corresponding to the plurality of third transmission data.

Next, the specific operations of the second embodiment will be described in detail below. In short, in addition to the operations executed in the first embodiment, in the second embodiment, when there are transmission data with a higher time class among the transmission data, the terminal device A may transmit an urgent data indicator (UDI) to the base station 2 to inform the base station 2 that there is urgent data with a higher time class to be processed. The terminal device A determines whether to transmit the BSR based on an UDI feedback returned by the base station 2.

Specifically, the UDI indicates a second transmission data and a second time class corresponding to the second transmission data, and the second time class corresponding to the second transmission data is higher than a default value (i.e., an UDI threshold). It shall be appreciated that the default value may be set by the base station 2 and notified to all the terminal devices.

For ease of understanding, please refer to the operation flow chart M2 of FIG. 5B. Since some of the operations are similar, the following will only describe the operations of the differences.

First, in the operation S506_1, the terminal device A may determine whether the time class corresponding to the transmission data is higher than a default value. When the result of the operation S506_1 is yes (e.g. positive), the terminal device A executes the operation S508 to transmit an UDI to the base station 2.

Next, in the operation S509, the terminal device A determines whether the received UDI feedback is equal to 1. When the UDI feedback is equal to 1, the terminal device A executes the operation S510 to cancel the transmission of the BSR. When the UDI feedback is not equal to 1 or the result of the operation S506_1 is no (e.g., negative), the terminal device A executes the operation S507 to transmit the BSR to the base station 2.

It shall be appreciated that the terminal device A may transmit the UDI to base station 2 through a scheduling request (SR), a hybrid automatic repeat request (HARQ), or a physical random access channel (PRACH), etc.

In some embodiments, when the terminal device A does not receive the UDI feedback from the base station 2 for a period of time, the terminal device A can retransmit the UDI to the base station 2 until the terminal device A transmits the next BSR to the base station 2.

In some embodiments, the base station 2 can generate the corresponding UDI feedback by evaluating its computing resources. Specifically, the UDI feedback is generated based on following operations: determining whether the remaining delay budget value corresponding to the second transmission data can be allocated to the data transmission schedule to generate the UDI feedback based on the UDI and a remaining computing resource corresponding to the data transmission schedule.

Specifically, the UDI feedback is used to indicate whether the second transmission data (i.e., the transmission data with a time class higher than a default value) can be allocated to the data transmission schedule within the remaining delay budget value corresponding to the second transmission data.

It shall be appreciated that, in the present example, when the UDI feedback returned by the base station 2 is not equal to 1 (i.e., equal to 0), it means that the base station 2 can allocate resources to the terminal device A within the time limit. In addition, when the UDI feedback returned by the base station 2 is equal to 1, it means that the base station 2 does not have resources that can schedule the first transmission data within the time limit. Therefore, in order to avoid wasting of resources, the terminal device A may cancel the transmission of the BSR, and the base station 2 can allocate the unused resources to other terminal devices for use.

It shall be appreciated that content 1 or 0 of the aforementioned UDI feedback is only for illustration, but not to limit the scope of the present disclosure. The content may be adjusted according to different settings or implementations during actual operation.

In some implementations, the remaining delay budget notification is selected to be transmitted synchronously with one of following signals including: a downlink control (DL) information (DCI), a new data indicator (NDI), or a new layer 1 signaling.

In some embodiments, in response to the UDI feedback indicating that the second transmission data cannot be allocated to the data transmission schedule within the remaining delay budget value corresponding to the second transmission data, the terminal device A excludes the second transmission data when generating the BSR to avoid wasting of resources.

The specific operations of the third embodiment will be described in detail below. In short, in addition to the operations executed in the first embodiment, in the third embodiment, when the terminal device A has a configuration of the remaining delay budget value reporting (RDB reporting) function, the terminal device A may add a field in the BSR for reporting the remaining delay budget value to report the time class of the first transmission data to the base station 2. After receiving the report of the remaining delay budget value transmitted by the terminal device A, the base station 2 may refer to the report given by each terminal device, and return the remaining delay budget notification (RDB notification) to the terminal device A according to the current network conditions, so as to inform the terminal device A that transmitting the transmission data with a time class higher than a certain time class (i.e., time class threshold) can be able to be scheduled.

In some embodiments, the terminal device A may generate a second BSR based on the time class threshold, and transmit the second BSR to the base station 2. For example, when the base station 2 informs the terminal device A that the remaining delay budget notification is 3 (i.e., the time class of the transmitted transmission data must below 3), the terminal device A may generate the second BSR based on the transmission data below the time class 3, and exclude the transmission data above the time class 3 (e.g., the transmission data with time classes 0, 1 or 2).

For ease of understanding, please refer to the operation flow chart M3 of FIG. 5C. Since some of the operations are similar, the following will only describe the operations of the differences.

First, in the operation S506_2, the terminal device A may determine whether the terminal device configures the remaining delay budget value reporting function. When the result of the operation S506_2 is yes, the terminal device A executes the operation S511 to transmit the BSR including the remaining delay budget value to the base station 2. When the result of operation S506_2 is no, the terminal device A executes the operation S507 to transmit the BSR to base station 2.

In some embodiments, the remaining delay budget notification is selected to be transmitted synchronously with one of following signals including: a DCI, a NDI, or a new layer 1 signaling.

The specific operations of the fourth embodiment will be described in detail below. In short, in addition to the operations executed in the first embodiment, the second embodiment, and the third embodiment, in the fourth embodiment, the terminal device A may combine the operations S506_1 in the second embodiment and the third embodiment in the operation of S506_2.

For ease of understanding, please refer to the operation flow chart M4 of FIG. 5D. Since some of the operations are similar, the following will only describe the operations of the differences.

First, in the operation S506_1, the terminal device A may determine whether the time class corresponding to the transmission data is higher than a default value. When the result of the operation S506_1 is yes, the terminal device A executes the operation S508 to transmit an UDI to the base station 2.

Next, in operation S509, the terminal device A determines whether the received UDI feedback is equal to 1. When the UDI feedback is equal to 1, the terminal device A executes the operation S510 to cancel the transmission of the BSR.

In addition, when the UDI feedback is not equal to 1 or the result of the operation S506_1 is no, the terminal device A executes the operation S506_2 to determine whether the terminal device A is configured with the remaining delay budget reporting function. When the result of the operation S506_2 is yes, the terminal device A executes the operation S511 to transmit the BSR including the remaining delay budget value to the base station 2. When the result of operation S506_2 is no, the terminal device A executes the operation S507 to transmit the BSR to the base station 2.

According to the above descriptions, the base station 2 and the terminal device A provided by the present disclosure calculates the corresponding remaining delay budget value for each of the transmission data by the terminal device A, and transmits the remaining delay budget value in the BSR to share information to the base station. In addition, the transmission technology provided by the present disclosure also shares various mechanisms for scheduling information through the terminal device A and the base station 2, so that the transmission data to the base station 2 can be carried out within the time limit. Therefore, the accuracy of the terminal device A determining the transmission data is improved, and the efficiency of the base station 2 scheduling is improved.

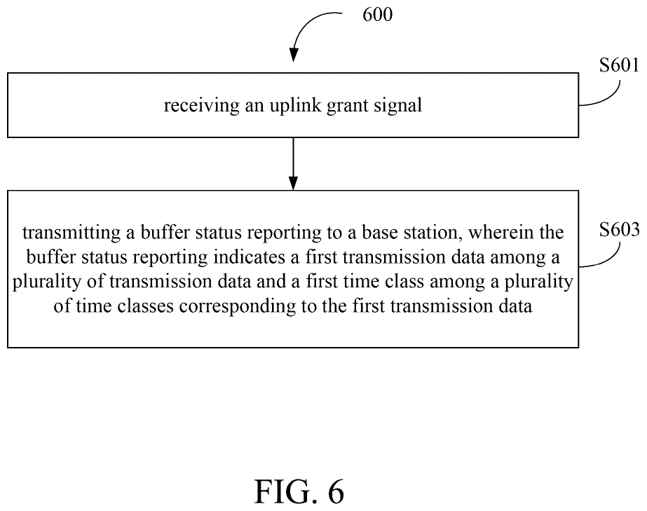

A fifth embodiment of the present disclosure is a transmission method and a flowchart thereof is depicted in FIG. 6. The transmission method 600 is adapted for a wireless communication system (e.g., the wireless communication system 1 of the first embodiment). The wireless communication system includes a base station and a plurality of terminal devices, such as the base station 2 and the terminal devices A, B, C and D described in the first embodiment. The transmission method 600 is executed by an electronic apparatus (e.g., the terminal device A). The transmission method 600 transmits a BSR to a base station through the steps S601 to S603.

In the step S601, the electronic apparatus receives an uplink grant signal. Next, in the step S603, the electronic apparatus transmits a BSR to a base station, wherein the BSR indicates a first transmission data among a plurality of transmission data and a first time class among a plurality of time classes corresponding to the first transmission data. The base station determines a data transmission schedule of the first transmission data based on the first time class and a remaining delay budget table, and the remaining delay budget table includes the time classes and a remaining delay budget value corresponding to each of the time classes.

In some embodiments, the transmission method 600 further includes following steps: comparing the remaining delay budget table to obtain the remaining delay budget value corresponding to the first time class; and determining the data transmission schedule of the first transmission data based on the remaining delay budget value corresponding to the first time class.

In some embodiments, wherein each of the transmission data corresponds to a delay budget, and the BSR is generated based on following steps: calculating, by the terminal device, the remaining delay budget value of each of the transmission data based on the delay budget and an elapsed time; and determining, by the terminal device, the first transmission data and the first time class in the BSR based on the remaining delay budget table and the remaining delay budget value of each of the transmission data.

In some embodiments, the transmission method 600 further includes following steps: transmitting an UDI; receiving an UDI feedback from the base station, wherein the UDI feedback corresponds to the UDI; and determining whether to transmit the BSR based on the UDI feedback.

In some embodiments, the UDI indicates a second transmission data and a second time class corresponding to the second transmission data, and the second time class corresponding to the second transmission data is higher than a default value.

In some embodiments, the UDI feedback is used to indicate whether the second transmission data can be allocated to the data transmission schedule within the remaining delay budget value corresponding to the second transmission data.

In some embodiments, wherein the BSR is generated based on following steps: excluding, by the terminal device, the second transmission data when generating the BSR in response to the UDI feedback indicates that the second transmission data cannot be allocated to the data transmission schedule within the remaining delay budget value corresponding to the second transmission data.

In some embodiments, wherein the UDI feedback is generated based on following steps: determining whether the remaining delay budget value corresponding to the second transmission data can be allocated to the data transmission schedule to generate the UDI feedback based on the UDI and a remaining computing resource corresponding to the data transmission schedule.

In some embodiments, each of the transmission data is further corresponding to a priority level, and the first transmission data is generated based on following steps: in response to the transmission data including a plurality of third transmission data corresponding to the same time class, determining the first transmission data based on the priority levels corresponding to the plurality of third transmission data.

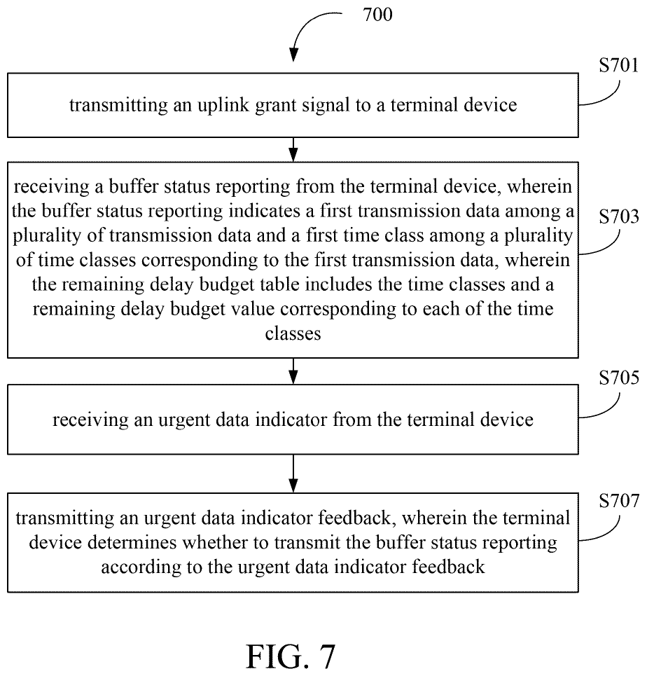

A sixth embodiment of the present disclosure is a transmission method and a flowchart thereof is depicted in FIG. 7. The transmission method 700 is adapted for a wireless communication system (e.g., the wireless communication system 1 of the first embodiment). The wireless communication system includes a base station and a plurality of terminal devices, such as the base station 2 and the terminal devices A, B, C and D described in the first embodiment. The transmission method 700 is executed by an electronic apparatus (e.g., the base station 2). The transmission method 700 transmits an UDI feedback to a terminal device through the steps S701 to S707.

In the step S701, the electronic apparatus transmits an uplink grant signal to a terminal device. Next, in the step S703, the electronic apparatus receives a BSR from the terminal device, wherein the BSR indicates a first transmission data among a plurality of transmission data and a first time class among a plurality of time classes corresponding to the first transmission data, wherein the remaining delay budget table includes the time classes and a remaining delay budget value corresponding to each of the time classes.

Next, in the step S705, the electronic apparatus receives an UDI from the terminal device. Finally, in the step S707, the electronic apparatus transmits an UDI feedback, wherein the terminal device determines whether to transmit the BSR according to the UDI feedback.

In addition to the aforesaid steps, the fifth and sixth embodiments can also execute all the operations and steps of the wireless communication system 1, the base station 2, and the terminal device A set forth in the first embodiment, the second embodiment, the third embodiment, and the fourth embodiment, have the same functions, and deliver the same technical effects as the first embodiment. How the fifth and sixth embodiments execute these operations and steps, have the same functions, and deliver the same technical effects will be readily appreciated by those of ordinary skill in the art based on the explanation of the first embodiment to the fourth embodiment. Therefore, the details will not be repeated herein.

It shall be appreciated that in the specification and the claims of the present disclosure, some words (e.g., the transmission data, the BSR, and the time class) are preceded by terms such as “first” and “second”, and these terms of “first” and “second” are only used to distinguish these different words. For example, the “first” and “second” BSR are only used to indicate the BSR used in different operations.

According to the above descriptions, the transmission technology (including the base station, the terminal device, and the method) in the wireless communication system provided by the present disclosure calculates the corresponding remaining delay budget value for each of the transmission data by the terminal device, and transmits the remaining delay budget value in the BSR to share information to the base station. In addition, the transmission technology provided by the present disclosure also shares various mechanisms for scheduling information through the terminal device and the base station, so that the transmission data to the base station can be carried out within the time limit. Therefore, the accuracy of the terminal device determining the transmission data is improved, and the efficiency of the base station scheduling is improved.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A terminal device in a wireless communication system, comprising:
a storage, being configured to store a remaining delay budget table and a set of instructions or programs;
a transceiver interface; and
a processor, being electrically connected to the storage and the transceiver interface, and being configured to execute following operations when executing the set of instructions or programs:
receiving an uplink grant signal; and
transmitting a buffer status reporting to a base station, wherein the buffer status reporting indicates a first transmission data among a plurality of transmission data and a first time class among a plurality of time classes corresponding to the first transmission data,
wherein the base station determines a data transmission schedule of the first transmission data based on the first time class and the remaining delay budget table,
wherein the remaining delay budget table comprises the time classes and a remaining delay budget value corresponding to each of the time classes.

2. The terminal device of claim 1, wherein the data transmission schedule is determined based on following operations:
comparing the remaining delay budget table to obtain the remaining delay budget value corresponding to the first time class; and
determining the data transmission schedule of the first transmission data based on the remaining delay budget value corresponding to the first time class.

3. The terminal device of claim 1, wherein each of the transmission data corresponds to a delay budget, and the buffer status reporting is generated based on following operations:
calculating the remaining delay budget value of each of the transmission data based on the delay budget and an elapsed time; and
determining the first transmission data and the first time class in the buffer status reporting based on the remaining delay budget table and the remaining delay budget value of each of the transmission data.

4. The terminal device of claim 3, wherein the processor further executes following operations:
transmitting an urgent data indicator;
receiving an urgent data indicator feedback from the base station, wherein the urgent data indicator feedback corresponds to the urgent data indicator; and
determining whether to transmit the buffer status reporting based on the urgent data indicator feedback.

5. The terminal device of claim 4, wherein the urgent data indicator indicates a second transmission data and a second time class corresponding to the second transmission data, and the second time class corresponding to the second transmission data is higher than a default value.

6. The terminal device of claim 5, wherein the urgent data indicator feedback is used to indicate whether the second transmission data can be allocated to the data transmission schedule within the remaining delay budget value corresponding to the second transmission data.

7. The terminal device of claim 6, wherein the buffer status reporting is generated based on following operations:
excluding, by the terminal device, the second transmission data when generating, by the terminal device, the buffer status reporting in response to the urgent data indicator feedback indicating that the second transmission data cannot be allocated to the data transmission schedule within the remaining delay budget value corresponding to the second transmission data.

8. The terminal device of claim 6, wherein the urgent data indicator feedback is generated based on following operations:
determining whether the remaining delay budget value corresponding to the second transmission data can be allocated to the data transmission schedule to generate the urgent data indicator feedback based on the urgent data indicator and a remaining computing resource corresponding to the data transmission schedule.

9. The terminal device of claim 3, wherein each of the transmission data is further corresponding to a priority level, and the first transmission data is generated based on following operation:
in response to the transmission data comprising a plurality of third transmission data corresponding to the same time class, determining the first transmission data based on the priority levels corresponding to the plurality of third transmission data.

10. A base station in a wireless communication system, comprising:
a storage, being configured to store a remaining delay budget table and a set of instructions or programs;
a transceiver interface; and
a processor, being electrically connected to the storage and the transceiver interface, and being configured to execute following operations when executing the set of instructions or programs:
transmitting an uplink grant signal to a terminal device;
receiving a buffer status reporting from the terminal device, wherein the buffer status reporting indicates a first transmission data among a plurality of transmission data and a first time class among a plurality of time classes corresponding to the first transmission data, wherein the remaining delay budget table comprises the time classes and a remaining delay budget value corresponding to each of the time classes;
receiving an urgent data indicator from the terminal device;
transmitting an urgent data indicator feedback to the terminal device, wherein the terminal device determines whether to transmit the buffer status reporting according to the urgent data indicator feedback; and
determining a data transmission schedule of the first transmission data.

11. A transmission method, being adapted for use in a terminal device, wherein the transmission method comprises following steps:
receiving an uplink grant signal; and
transmitting a buffer status reporting to a base station, wherein the buffer status reporting indicates a first transmission data among a plurality of transmission data and a first time class among a plurality of time classes corresponding to the first transmission data,
wherein the base station determines a data transmission schedule of the first transmission data based on the first time class and a remaining delay budget table,
wherein the remaining delay budget table comprises the time classes and a remaining delay budget value corresponding to each of the time classes.

12. The transmission method of claim 11, wherein the transmission method further comprises following steps:
comparing the remaining delay budget table to obtain the remaining delay budget value corresponding to the first time class; and
determining the data transmission schedule of the first transmission data based on the remaining delay budget value corresponding to the first time class.

13. The transmission method of claim 11, wherein each of the transmission data corresponds to a delay budget, and the buffer status reporting is generated based on following steps:
calculating, by the terminal device, the remaining delay budget value of each of the transmission data based on the delay budget and an elapsed time; and
determining, by the terminal device, the first transmission data and the first time class in the buffer status reporting based on the remaining delay budget table and the remaining delay budget value of each of the transmission data.

14. The transmission method of claim 13, wherein the transmission method further comprises following steps:
transmitting an urgent data indicator;
receiving an urgent data indicator feedback from the base station, wherein the urgent data indicator feedback corresponds to the urgent data indicator; and
determining whether to transmit the buffer status reporting based on the urgent data indicator feedback.

15. The transmission method of claim 14, wherein the urgent data indicator indicates a second transmission data and a second time class corresponding to the second transmission data, and the second time class corresponding to the second transmission data is higher than a default value.

16. The transmission method of claim 15, wherein the urgent data indicator feedback is used to indicate whether the second transmission data can be allocated to the data transmission schedule within the remaining delay budget value corresponding to the second transmission data.

17. The transmission method of claim 16, wherein the buffer status reporting is generated based on following steps:
excluding, by the terminal device, the second transmission data when generating, by the terminal device, the buffer status reporting in response to the urgent data indicator feedback indicating that the second transmission data cannot be allocated to the data transmission schedule within the remaining delay budget value corresponding to the second transmission data.

18. The transmission method of claim 16, wherein the urgent data indicator feedback is generated based on following steps:
determining whether the remaining delay budget value corresponding to the second transmission data can be allocated to the data transmission schedule to generate the urgent data indicator feedback based on the urgent data indicator and a remaining computing resource corresponding to the data transmission schedule.

19. The transmission method of claim 13, wherein each of the transmission data is further corresponding to a priority level, and the first transmission data is generated based on following step:
in response to the transmission data comprising a plurality of third transmission data corresponding to the same time class, determining the first transmission data based on the priority levels corresponding to the plurality of third transmission data.

20. A transmission method, being adapted for use in a base station, wherein the base station stores a remaining delay budget table, and the transmission method comprises following steps:
transmitting an uplink grant signal to a terminal device;
receiving a buffer status reporting from the terminal device, wherein the buffer status reporting indicates a first transmission data among a plurality of transmission data and a first time class among a plurality of time classes corresponding to the first transmission data, wherein the remaining delay budget table comprises the time classes and a remaining delay budget value corresponding to each of the time classes;
receiving an urgent data indicator from the terminal device;
transmitting an urgent data indicator feedback, wherein the terminal device determines whether to transmit the buffer status reporting according to the urgent data indicator feedback; and
determining a data transmission schedule of the first transmission data.
